(19) United States
(12) Patent Application Publication
(10) Pub. No.: US 2017/0236231 A1
(43) Pub. Date: Aug. 17, 2017

(54) Emergency Evacuation Procedure and Monitoring

(71) Applicant: Bayerische Motoren Werke Aktiengesellschaft, Muenchen (DE)

(72) Inventor: Kevin KERSHAW, Union, SC (US)

(21) Appl. No.: 15/042,821

(22) Filed: Feb. 12, 2016

(51) Int. Cl. G06Q 50/26; G06Q 10/00

(52) U.S. Cl. CPC G06Q 50/265; G06Q 10/00

(57) ABSTRACT

A system and method for emergency evacuation procedure and monitoring is provided. The system, for example, may include one or more computing devices and a plurality of scanning devices communicatively coupled to the one or more computing devices. The plurality of scanning devices may be located at pre-designated locations on the premises of business, for example. The one or more computing devices may be configured to receive, via the plurality of scanning devices, information associated with an individual on the premises, tally the received information associated with the individual, and determine that the individual has been accounted for based at least in part on a match between the received information associated with the individual and previously stored information associated with the individual.

### BACKGROUND

Emergency evacuation is the immediate and urgent movement of people away from the threat or actual occurrence of one or more hazards, such as fires, traffic accidents including train or aviation accidents, structural failures, biological outbreaks (e.g., viral, bacterial), military attacks, natural disasters (e.g., floods, hurricanes, earthquakes, tsunamis, bushfires, cyclones, volcano eruptions) and industrial accidents (e.g., chemical spills).

Evacuation plans may be developed to ensure safe and time efficient means of moving people away from a certain hazard. Evacuations may be implemented on both large and small scales. Large scale evacuations may be part of disaster management and may include evacuating thousands, if not, millions of people out of a large city, for example. Small scale evacuations may involve evacuating people from a building, or the premises of a business, school, or office, for instance, that may include multiple buildings.

Common examples of equipment in buildings that may facilitate small scale evacuations include fire alarms, exit signs, emergency lights, and the like. In some instances, alternative escape routes via staircases, ladders, or windows may be available for people escaping a building.

However, the ability to effectively track and monitor every person during an emergency evacuation is limited. For example, there is no current way of monitoring the location of individuals during an emergency situation. Accordingly, there is a need to account for the people who have safely moved away from a particular hazard as well as locate, track, and monitor the individuals who have not yet safely evacuated.

### SUMMARY OF THE INVENTION

According to one example of the present disclosure, a system for emergency evacuation procedure and monitoring is provided. The system may include one or more computing devices and a plurality of scanning devices communicatively coupled to the one or more computing devices. The plurality of scanning devices may be located at pre-designated locations on the premises of business, for example. The one or more computing devices may be configured to receive, via the plurality of scanning devices, information associated with an individual on the premises, tally the received information associated with the individual, and determine that the individual has been accounted for based at least in part on a match between the received information associated with the individual and previously stored information associated with the individual.

According to another example of the present disclosure, a method for emergency evacuation procedure and monitoring is provided. The method may be implemented by one or more computing devices. The method may comprise the acts of receiving, via a plurality of scanning devices, information associated with an individual on the premises of a business, for example, tallying the received information associated with the individual, and determining, using the one or more computing devices, that the individual has been accounted for based at least in part on a match between the received information associated with the individual and previously stored information associated with the individual.

According to yet a further example of the present disclosure, a computing device for emergency evacuation procedure and monitoring is provided. The computing device may include at least one processer, the at least one processor executing stored program instructions to receive, via a plurality of scanning devices, information associated with an individual on a premises, for example, tally the received information associated with the individual, and determine that the individual has been accounted for based at least in part on a match between the received information associated with the individual and previously stored information associated with the individual.

Other objects, advantages and novel features of the present invention will become apparent from the following detailed description of one or more preferred embodiments when considered in conjunction with the accompanying drawings. It should be recognized that the one or more examples in the disclosure are non-limiting examples and that the present invention is intended to encompass variations and equivalents of these examples. The disclosure is written for those skilled in the art. Although the disclosure use terminology and acronyms that may not be familiar to the layperson, those skilled in the art will be familiar with the terminology and acronyms used herein.

### BRIEF DESCRIPTION OF THE DRAWINGS

FIG. 1 illustrates an example system in accordance with one or more aspects of the disclosure.

FIG. 2 illustrates an example premises in accordance with one or more aspects of the disclosure.

FIG. 3 illustrates an example scanning device in accordance with one or more aspects of the disclosure.

FIG. 4 illustrates an example building of the premises during evacuation procedure and monitoring in accordance with one or more aspects of the disclosure.

FIG. 5 is illustrates an example flow chart in accordance with one or more aspects of the disclosure.

### DETAILED DESCRIPTION OF THE INVENTION

The present disclosure is directed to a system and method for emergency evacuation procedure and monitoring. For example, identification information from identification badges, identification cards, fingerprints, retinal scans, etc. may be received at pre-designated locations (e.g., “safety zones”) on the premises of a business, for example, during an emergency situation via scanning devices. As the identification information of the various individuals are being scanned, received, and/or monitored (or after a certain period of time of scanning, receiving, and/or monitoring), one or more computing devices of a computer system may tally the information received from all the individuals who have checked-in to the safety zones so as to be able to generate a report of which individuals on the premises have been accounted for and which have not. The report, for instance, may be updated in real-time, and continuously, so that they it can be relayed to onsite security personnel, first responders, and/or a central dispatch system.

In one aspect of the disclosure, a series of “check points” may be distributed throughout the premises or various strategic locations (e.g., between a pair of safety zones) and may be configured to receive identification information of the individuals as they are moving toward a safety zone. The computer system, for example, may be able to track the progress of the individuals as they make their way toward a particular safety zone. In that regard, not only may the system be able to better identify the location of the individuals, but the system may also be able to determine whether someone is able to reach a safety zone within a certain time period. Moreover, the computer system may be able to assess the severity of the hazard or emergency in different areas of the premises so as to better guide and focus first responders' efforts on those most in need of help.

As will be further discussed below, a plurality of interconnected scanning devices (e.g., scanners) may be set up in or near a safety zone and/or check point in order to receive various types of information (such as identification information) from the individuals on the premises that check into that safety zone or check point. The scanning device may scan information that has been already made available to the individual, such as an identification badge, identification cards, fingerprint, retinal scan, etc.

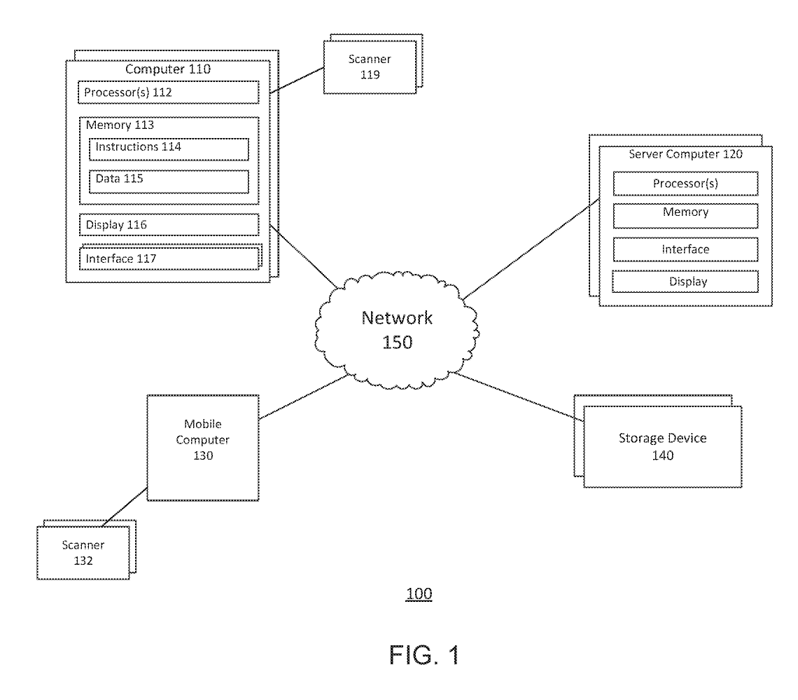

FIG. 1 illustrates an example system 100 in accordance with one or more aspects of the disclosure. The system may include a plurality of computers and/or computing devices, such as, computer 110, server computer 120, mobile computer 130, storage device 140, scanner 119, and scanner 132, all connected to network 150. By way of example only, computer 110 may include different types of components associated with a computer, such as one or more processors 112, memory 113, instructions 114, data 115, display 116, and an interface 117. Similarly, server computer 120 may also include one or more processors, memory, interface, and/or display and may be configured to communicate with at least one of computer 110, mobile computer 130, and storage device 140. In another example, the mobile computer 130 may be a laptop or Ultrabook (or any computing device that is or can be mobile) and also include components similar to the computer 110 and server computer 120. As illustrated by the cascaded blocks in FIG. 1, there may be more than one of each device or component connected inside the computer 110, server computer 120, mobile computer 130, storage device 140, and/or to the network 150. For instance, there may be more than one computer, mobile computer, storage device, and/or server computer connected to the network.

The processor 112 of computer 110 may instruct the components of computer 110 to perform various tasks based on the processing of information and/or data that may have been previously stored or have been received, such as instructions 114 and/or data 115 stored in memory 113. The processor 112 may be a standard processor, such as a central processing unit (CPU), or may be a dedicated processor, such as an application-specific integrated circuit (ASIC) or a field programmable gate array (FPGA). By way of example only, at least one control unit (not shown) coupled to an arithmetic logic unit (ALU) (not shown) and memory 113 may instruct the computer 110 to carry out program instructions 114 stored in memory 113. Although one processor block is shown in FIG. 1 to illustrate the processor 112, the computer 110 may also include multiple processors that may be connected in various configurations (e.g., in series, in parallel, etc.).

Memory 113 stores information and/or data that can be accessed by processor 112 including instructions 114 executable by the processor 112. Data 115 can be retrieved, manipulated or stored by the processor 112. For example, memory 113 may be hardware capable of storing information accessible by the processor, such as a ROM, RAM, hard-drive, CD-ROM, DVD, write-capable, read-only, etc.

The instructions 114 may include a set of instructions to be executed directly (e.g., machine code) or indirectly (e.g., scripts) by the processor 112. The set of instructions may be included in software that can be implemented on the computer 110. It should be noted that the terms “instructions,” “steps,” “algorithm,” and “programs” may be used interchangeably. For example (and as will be further discussed below), the instructions 114 may include at least a set of executable instructions to receive identification information from one or more persons on the premises and either to process the received information (e.g., tally the information, record, determine an individual's estimated time of arrival to a safety zone, determine location of an individual on the premises, etc.) on computer 110 and then send to server computer 120 and/or storage device 140 via network 150, or to first send the identification information to server computer 120 and/or storage device 140 via the network 170 and then process the information on at least one of those devices. The set of executable instructions included in the instructions 114 may originate from memory 114 or may be downloaded (e.g., an application) from a different computing device connected to network 150 (e.g., server computer 120, mobile computer 130, storage device 140) and then stored in memory 113.

The data 115 may be retrieved, stored, modified, and/or manipulated by the processor 112 in accordance with the set of instructions 114 or other sets of executable instructions stored in memory. The data 115 may be stored as a collection of data. The disclosure is not limited by any particular data structure and the data 115 may be stored in computer registers, in a database as a table having a plurality of different fields and records, such as an XML. The data 115 may also be formatted in any computer readable format such as, binary values, ASCII, EBCDIC (Extended Binary-Coded Decimal Interchange Code), etc.

As an example, the data 115 may include previously stored identification information of individuals on the premises, the number of individuals on the premises, received identification information of those individuals via a plurality of scanning devices to match with the previously stored information and determine whether all individuals have evacuated, locations of the safety zones and/or check points on or near the premises, physical distances between the safety zones and/or check points, various input data and information associated with certain hazards and disaster events such as fires, earthquakes, etc., the location and number of fire sprinklers, number of buildings on the premises, the location of the buildings, various design features of the buildings such as the number of floors, doors, windows, etc., as well as other types of information that may aid in evacuation procedure in accordance with aspects of the disclosure. As a further example, the data 115 may be received by the server computer 120, the mobile computer 130, and/or storage device 140 which may also store the data 115.

The display 116 may be any type of device capable of communicating data to a user, such as a liquid-crystal display (“LCD”) screen, a plasma screen, etc. For example, the display 116 may indicate to the user that “check in” has been complete. Interface 117 may be a device, port, or a connection that allows a user to communicate with the computer 110, such as a keyboard, a mouse, touch-sensitive screen, microphone, camera, etc., and may also include one or more input/output ports, such as a universal serial bus (USB) drive, CD/DVD drive, zip drive, various card readers, etc.

A plurality of interconnected scanning devices, such as scanner 119, may be communicatively coupled either directly or indirectly to the computer 110. The scanner 119 may also be, for instance, physically located within the housing of computer 110 or the like. As will be further described below, the scanner 119 may be configured to scan, receive and/or monitor various types of information from one or more individuals on the premises. By way of example, the information may be identification information that includes different types of data associated with the identity of an individual, such as name, date of birth, date of hire, type of individual (e.g., employee, visitor, etc.). Moreover, the scanner 119 may be configured to scan and receive biometric data such as fingerprints and retinal data. In some aspects, the plurality of scanning devices may be continuously active and operative to scan, receive, and/or monitor information, or in other aspects, the plurality of scanning devices may become active once an alert associated with an emergency situation (e.g., fire) is detected. As shown by the cascaded block behind scanner 119, there may be more than one scanner coupled to the computer 110. “Scanning” is not to be understood as being limited in scope, for example, scanning devices may include any type of device capable of receiving information, such as image capturing devices, e.g., cameras, camcorders, etc.

The server computer 120 (and additional server computers) may be rack mounted on a network equipment rack and/or located, for instance, in a data center. In one example, the server computer 120 may use the network 150 to serve the requests of programs executed on computer 110, mobile computer 130, and/or storage device 140. The server computer 120 may allow certain computing devices connected to network 150 to access the data 115 (stored in e.g., computer 110, server computer 120, and storage device 140).

Mobile computing devices, such as the mobile computer 130 may also have similar components and/or functions to computer 110 and server computer 120, such as one or more processors, memory, instructions, data, input/output capabilities, display, interfaces, etc. For example, the mobile computer 130 may be any type of mobile device with computing capability and/or connectivity to a network, such as a laptop, Ultrabook, smartphone, PDA, tablet computer, etc. The mobile computer 130 may be able to connect to network 150 using a wired connection or a wireless connection to communicate with the other various devices of the network 150. Moreover, similar to computer 110, a plurality of scanning devices, such as scanner 132 may be communicatively coupled either directly or indirectly to the mobile computer 130. The scanner 132 may be configured similarly to the scanner 119 described above.

The storage device 140 illustrated in FIG. 1 may be configured to store a large quantities of data and/or information. For example, the storage device 140 may be a collection of storage components, or a mixed collection of storage components, such as ROM, RAM, hard-drives, solid-state drives, removable drives, network storage, virtual memory, cache, registers, etc. The storage device 140 may also be configured so that the server computer 120 may access it via the network 150, or so that computer 110 and/or mobile computer 130 may either directly or indirectly access storage device 140.

By way of example only, the storage device 140 may store the above-described information with respect to data 115 including previously stored identification information of individuals on the premises, received identification information of those individuals via a plurality of scanning devices, locations of the safety zones and/or check points, physical distances between the safety zones and/or check points, various input data and information associated with certain hazards and disaster events, the location and number of fire sprinklers, number of buildings on the premises, the location of the buildings, various design features of the buildings, and other types of information.

The network 150 may be any type of network, wired or wireless, configured to facilitate the communication and transmission of data, instructions, etc. from one component to another component of the network. For example, the network 170 may be a local area network (LAN) (e.g., Ethernet or other IEEE 802.03 LAN technologies), Wi-Fi (e.g., IEEE 802.11 standards, wide area network (WAN), virtual private network (VPN), global area network (GAN)), any combination thereof, or any other type of network.

While processor 112, memory 113, display 116 and interface 117 of computer 110 are functionally illustrated in FIG. 1 in the same blocks, it will be understood that they may include multiple processors, memories, displays or interfaces that may not be stored within the same physical housing. Moreover, the system and operations described herein and illustrated in FIG. 1 will now be described below, and the operations are not required to be performed in a particular or precise order. Rather, it is understood that the operations may be performed in a different order, different combinations, or simultaneously, etc.

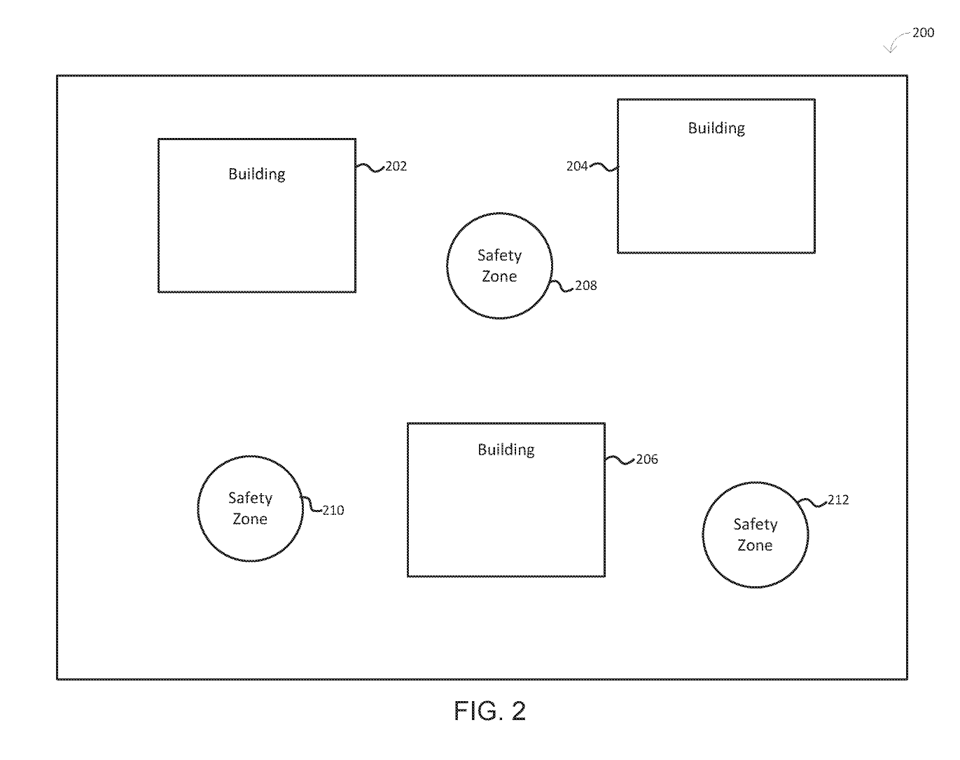

As described above, pre-designated locations (or “safety zones”) where individuals can check-in during an emergency evacuation may be dispersed throughout, for example, the premises of a business. FIG. 2 illustrates premises 200 of a business from a top view in accordance with one or more aspects of the disclosure.

As illustrated, premises 200 of the business may include three different physical structures: building 202, building 204, and building 206. The buildings in this example may be similar in size and shape, but it is understood that the buildings of premises 200 may also be of different shapes and sizes. Premises 200 further includes safety zone 208, safety zone 210, and safety zone 212. The safety zones may be strategically placed around the premises 200, for example, near emergency exits of the buildings 202, 204, and 206, or where it is convenient or efficient for a large quantity of people to move toward, such as an open space, parking lot, etc.

In FIG. 2, for example, each safety zone is positioned adjacent to at least two buildings (e.g., safety zone 208 adjacent to buildings 202, 204, and 206, safety zone 210 adjacent to buildings 202 and 206, safety zone 212 adjacent to buildings 204 and 206). While the premises 200 of FIG. 2 only shows three different safety zones, it is again understood that premises 200 may include more safety zones, as necessary, depending on the number of people on the premises, size of the buildings, level of activity in those buildings, etc. Moreover, depending on the topology of the premises, it can also be understood that in some instance, the safety zones may be located outside the physical boundaries of the premises.

Each of the safety zones 208, 210, and 212 may include a plurality of interconnected scanning devices to scan, receive, and/or monitor identification information corresponding to every individual that “checks-in” to the safety zone. As noted above, the scanning devices may be any device that can scan, receive, and/or monitor information, such as scanner 119 coupled to computer 110 and scanner 132 coupled to the mobile computer 130. The scanners may be placed within the boundaries of the safety zones 208, 210, and 212 in order to encourage the individuals checking in to not wander outside of the boundaries, which may expose them to greater hazards or risks. For example, scanner 119 may be placed within safety zone 208, or scanner 132 may be placed within safety zone 210 (or safety zone 212). As noted above, the plurality of interconnected scanning devices may be continuously active and operative to scan, receive, and/or monitor for identification information. In other instances, the plurality of scanning devices may become active once an emergency event is detected. In that regard, energy costs may be saved and the scanning devices would not receive false scans, for example, as a group of people walk past scanner 119 from building 202 to building 204.

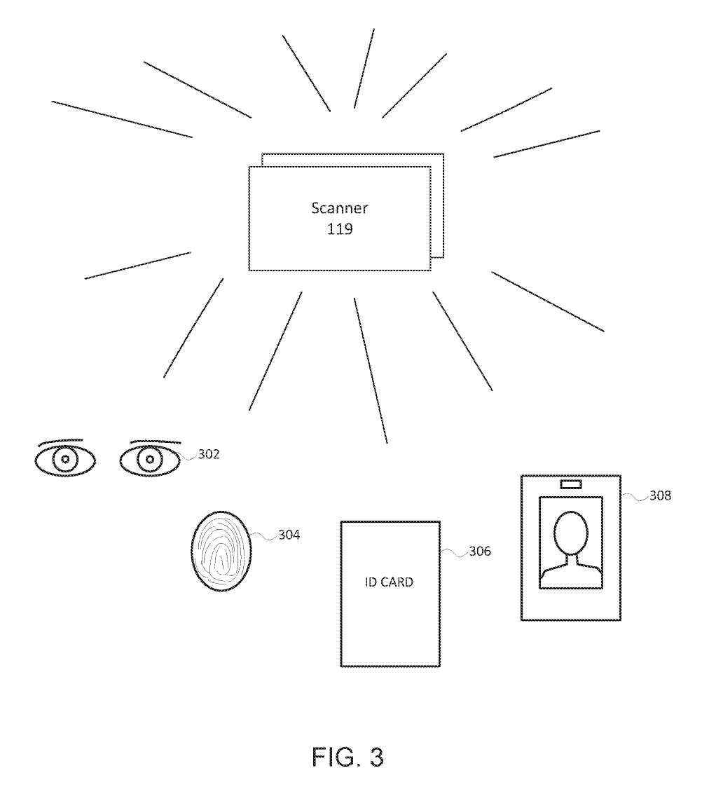

FIG. 3 illustrates the various types of information that the plurality of scanners may be configured to scan and receive in accordance with one or more aspects of the disclosure. By way of example only, scanner 119 may be communicatively coupled to computer 110 and may be placed within safety zone 208, as described above. As such, when an individual enters into safety zone 208 during an emergency evacuation, the individual may check-in with different types of information sources. FIG. 3, for instance, shows an individual's retina 302, an individual's fingerprint 304, an identification card 306, and an identification badge 308. In that regard, the scanner 119 may scan, receive, and/or monitor different types of information (e.g., biometric information from the retina 302 and fingerprint 304, digital/analog data from the identification card 306 and identification badge 308) in order to be able to report which individuals have been accounted for and which have not.

In one aspect, whether an individual can check in with biometric data may depend on the role of the individual on the premises (e.g., occupation, title). For instance, if the individual who works on the premises 200 is an employee, for example, the employee may be able to check-in at a safety zone using retina 302 or fingerprint 304. As an employee, on the date of hire for instance, the biometric data associated with this individual may have been recorded and stored in the company's system for situations such as emergency evacuations. Accordingly, if for some reason the employee forgets or does not have identification badge 308 (which may include the employee's photo, name, and title as show in FIG. 3), biometric data such as retina 302 or fingerprint 304 may be scanned by the scanner 119 to complete the check-in procedure.

In a further aspect, there may be visitors on premises 200 of the business. Visitors may be given identification card 306 when the visitor first enters premises 200. For example, the identification card 306 may state “visitor” including the visitor's name, date of visit, duration of visit, who the visitor is visiting, and the like. Both the identification card 306 and identification badge 308 may include chipsets or other electrical components, such as radio-frequency identification (RFID) tags, that may be configured to store and transmit information wirelessly. Although FIG. 3 illustrates retina 302, fingerprint 304, identification card 306, and identification badge 308, it may be understood that other types of physical devices, biometric information and/or combination of numbers/letters (e.g., passcodes, passwords) may be scanned and/or inputted into the plurality of scanning devices (or the computer coupled to the scanning devices).

Once identification information associated with an individual in safety zone 208 is scanned, received, and/or monitored by scanner 119, the computer 110 (which may be connected to network 150) may transmit the information to server computer 120 to record and/or tally the received information and that the individual related to the received information is accounted for during evacuation. Alternatively, the recording and/or tallying of the received information from the individuals within safety zone 208 may be performed by the computer 110, and at certain time intervals, transmit the information to server computer 120. In addition to safety zones located throughout the premises 200, there may be a plurality of check points also located throughout the premises 200 (as well as inside of the buildings).

According to one example, the check points may operate only during emergency evacuation procedure. Similar to the configuration of the safety zones, check points may also include a plurality of scanning devices which may be communicatively coupled to respective computing devices. By way of example only, the check points may scan, receive, and/or monitor identification information of individuals as those individuals make their way to a particular safety zone. In that regard, the location, movement, pace, etc. of the individuals who have not yet checked-in at a safety zone may be tracked in order to determine the status of the safety of those individuals and further determine the estimated time of arrival of the individuals to a particular safety zone.

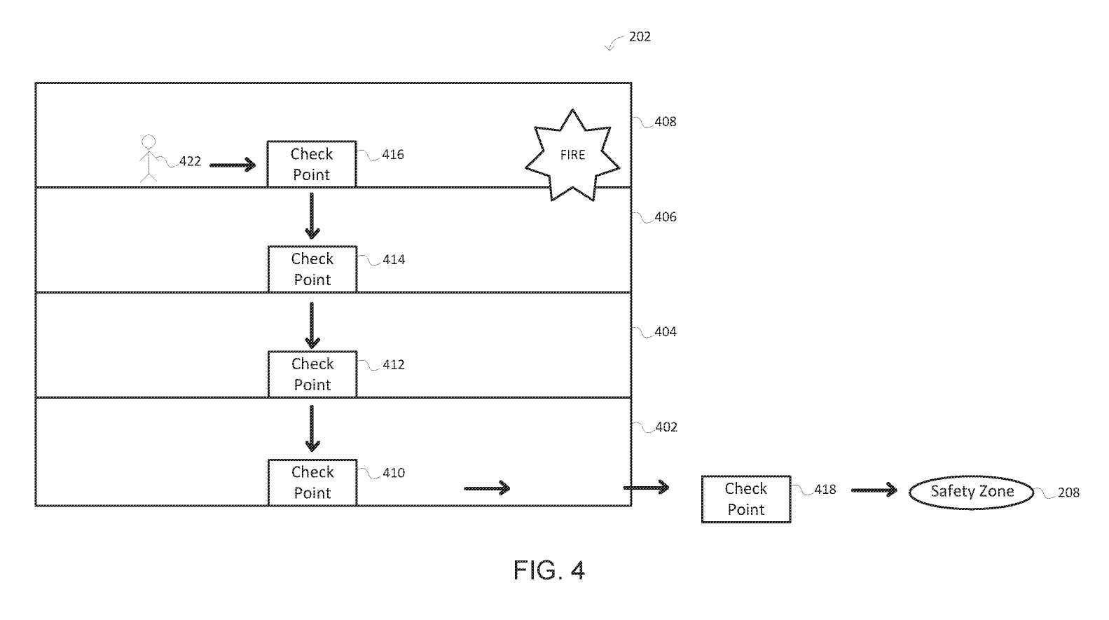

FIG. 4 illustrates a cross-sectional view of building 202, which includes various check points arranged inside and outside the building 202 in accordance with one or more aspects of the disclosure. As shown, building 202 has four different levels: floor 402, floor 404, floor 406, and the top-most floor 408. FIG. 4 further illustrates a check point located on each level, e.g., check point 410 on level 402, check point 412 on level 404, check point 414 on level 406, check point 416. Moreover, a fifth check point, e.g., check point 406, may be located outside of building 202, e.g., between building 202 and safety zone 208.

Similar to the safety zones described above, the check points may be arranged in strategic locations. For example, check points 410, 412, 414, and 416 may be located near emergency exits since an individual during evacuation may be more likely exit from an emergency exit than exit from a non-emergency exit. In some instances, it may be preferable that the check points are physically small in size and occupy minimal space so as to arrange more check points in buildings or areas with limited space. In that regard, small, compact computing devices such as the mobile computing device 130 illustrated in FIG. 1 may be used. For instance, the configuration of the mobile computer 130 communicatively coupled to scanner 132 may arranged within the check points. Moreover, while FIG. 4 illustrates only five different check points, it is understood that there may be more, or less, check points depending on the layout of the building and its location in relation to one or more surrounding checkpoints. There may be more than check point 418 arranged between building 202 and safety zone 208, for instance, to better track and locate the individuals that have not yet been accounted for during an emergency evacuation procedure.

By way of the example illustrated in FIG. 4, building 202 may have to be evacuated due to a fire that has spread on floor 408. At this time, the system and method for emergency evacuation procedure according to the disclosure may be initiated and all the devices within both the safety zones and check points may be fully operational. It may be known that, at the time of evacuation, 90 employees and 10 visitors are inside building 202. This information, along with the identification information of the 90 employees and 10 visitors may have been previously recorded and stored within a database and/or memory (e.g., storage device 140, memory 113) of a system (e.g., system 100).

During the evacuation procedure illustrated, the system 100 and one or more components thereof such as computer 110, mobile computer 130, server computer 120, for instance, may determine that 89 employees and all 10 visitors have “checked-in” to safety zone 208. As described above, the system 100 may record and tally identification information associated with the employees and visitors received by scanning devices located within safety zone 208. Moreover, the system 100 may determine whether the received identification information from those employees and visitors match the information that are stored in the database. This may be done to “account for” the employees and visitors who have properly check-in to safety zone 208. After the matching procedure (or simultaneously with the matching procedure), the system 100 may report that the employees and visitors have been accounted for. The reporting may be performed each time an employee or visitor checks-in or may be batch reported after a particular period of time. Accordingly, the system 100 will ultimately have reported that 89 employees and all 10 visitors of building 202 have been accounted for during the evacuation procedure.

In a further aspect of the example illustrated in FIG. 4, the system 100 may determine whether any individuals have not been accounted for. This may be performed in various ways. For instance, the system 100 may query the list of previously stored information in the database and identify the individuals who have not yet been “matched,” as described above. Server computer 120 of system 100, as an example, may determine that employee 422, who works in building 202, has not checked-in to safety zone 208 (or any of the other safety zones dispersed on the premises 200). Then, server computer 120 may use all information scanned, received, and/or monitored from the check points (e.g., check points 410, 412, 414, 416, and 418) to determine at least location of employee 422, movement, pace, estimated time that the employee 422 will arrive at a particular safety zone, etc.

Employee 422 may be evacuating from floor 408 of building 202. As such, the employee 422 may find the nearest emergency exit and exit using the exit staircase. At that point in time, check point 416 may monitor and receive identification information associated with employee 422 from an identification badge. Server computer 120 may record the time at which check point 416 received this information.

Thereafter, employee 422 may pass check point 414 as employee 422 hurries down the staircase of building 202. Again, server computer 120 may record the time at which employee 422 receives the identification information. At this point in time, the server computer 120 may determine at least two types of information: the location of employee 422 based on the location of check points 416 and 414 and the pace/speed of the movement of employee 422. For example, the distance between check point 416 and check point 414 may be known. Based on when the check points received the identification information, server computer 120, for instance, may determine pace/speed data. Using these types of information, the system 100 may be able to predict how long it will take employee 422 to reach safety zone 208 (or other safety zones), or how likely the employee 422 will reach safety zone 208 within a particular time, using known distance information (e.g., distance between check point 410 and check point 418, distance between check point 418 and safety zone 208). In that regard, the system 100 may determine whether employee 422 needs assistance evacuating, or may alert the closest first responders to help employee 422.

Moreover, the system 100 and various components thereof may be configured to receive numerous input related to the type of disaster or hazard that triggered the emergency evacuation procedure. By way of example only, an individual who has already checked-in to a safety zone may input via computer 110 that the hazard is a fire spreading in building 202. In another example, system 100 may detect that more than a predefined number of sprinklers (e.g., 10) are currently activated in building 202 and determine the corresponding severity of the fire (or how fast the fire may be spreading based on the rate of sprinkler activation in different areas of the building). With such information, system 100 may be able to better assist and facilitate the evacuation of building 202 as well as other buildings on premises 200 that may be affected.

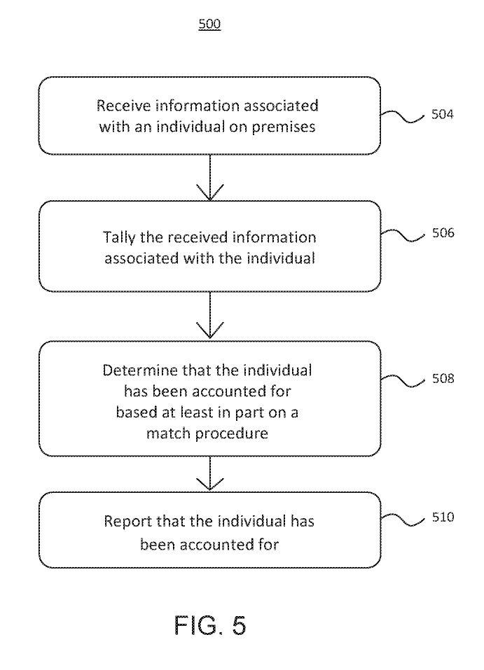

FIG. 5 illustrates an example flow chart in accordance with one or more aspects of the disclosure. By way of example, at block 504, a component of system 100 (illustrated in FIG. 1), such as server computer 120, may receive information associated with an individual on the premises via the plurality of scanning devices at either the safety zone or check points. At block 506, the server computer 120 may tally the received information associated with the individual locally (in memory within server computer 120) or to a central database, such as storage device 140 of network 150.

At block 508, as described above, for example, with respect to FIG. 4, the server computer 120 may determine that the individual has been accounted for based at least in part on a match procedure. The match or matching procedure may involve matching the received information, which may be identification information, to previously stored identification information associated with that individual, e.g., information inputted into a central database on the date of hire of the individual. Moreover, the server computer 120 may also determine whether any individuals have not been accounted for and subsequently determine the whereabouts of the unaccounted individuals, as well as their locations, movement, pace, and their estimated time of arrival to a particular safety zone. At block 510, the server computer 120 may report, or generate a report, that the individual has been accounted for. The report may be sent to other components or devices of network 150, such as storage device 140.

While the flow chart illustrated in FIG. 5 was described with respect to the server computer 120 of system 100, it can be understood that other components of the network 150 may perform, compute, and/or process the steps shown in FIG. 5. Moreover, it is to be understood that while the system 100 and corresponding network 150 was used to describe the above-examples of the disclosure, more than one network may be used to implement the system and method for handling emergency evacuation procedure.

Numerous advantageous of the present disclosure, include but are not limited to, the safe, efficient, and effective facilitation of emergency evacuation. For example, the ability to track and account for, in real-time, all individuals on a particular premises, and further, the ability to locate and track the movement, pace, and estimates various times with respect to unaccounted individuals on the premises, may reduce the loss of lives during an evacuation event. In a further example, the system for handing the emergency evacuation procedure according to the disclosure may be dynamic, and as such, may be able to adapt and process different types of evacuation scenarios and circumstances.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A system for emergency evacuation procedure and monitoring, the system comprising:
one or more computing devices; and
a plurality of scanning devices communicatively coupled to the one or more computing devices,
wherein the plurality of scanning devices are located at pre-designated locations of a premises,
wherein the one or more computing devices are configured to:
receive, via the plurality of scanning devices, information associated with an individual on the premises,
tally the received information associated with the individual, and
determine that the individual has been accounted for based at least in part on a match between the received information associated with the individual and previously stored information associated with the individual.

2. The system of claim 1, wherein the pre-designated locations are safety zones and check points.

3. The system of claim 2, wherein the determination that the individual has been accounted for is made if the information associated with the individual was received at a safety zone, and the one or more computing devices are further configured to generate a report that the individual has been accounted for.

4. The system of claim 3, wherein the one or more computing devices are further configured to:
determine whether any individuals have been unaccounted for; and
for each unaccounted individual, determine an approximate location of the unaccounted individual based at least in part on a location of a first check point where information associated with the unaccounted individual was last received.

5. The system of claim 4, wherein the one or more computing devices are further configured to:
identify that the unaccounted individual is moving based at least in part on a second check point receiving the information associated with the unaccounted individual; and
determine a pace of movement of the unaccounted individual based at least in part on when the information associated with the unaccounted individual was received at the first check point and the second check point, respectively, and a distance between the first check point and the second check point.

6. The system of claim 5, wherein the one or more computing devices are further configured to determine whether the unaccounted individual will arrive at a safety zone within a time period.

7. The system of claim 1, wherein the received information associated with the individual on the premises is identification information.

8. The system of claim 7, wherein the identification information originates from at least one of an identification card, an identification badge, a fingerprint, and a retina.

9. The system of claim 1, wherein the previously stored information associated with the individual is stored in a database and includes information corresponding to identity.

10. The system of claim 1, wherein the one or more computing devices are further configured to receive input related to one or more hazards associated with an emergency being handled in order to determine a severity of the emergency.

11. A method for emergency evacuation procedure and monitoring implemented by one or more computing devices, the method comprising the acts of:
receiving, via a plurality of scanning devices, information associated with an individual on a premises;
tallying the received information associated with the individual; and
determining, using the one or more computing devices, that the individual has been accounted for based at least in part on a match between the received information associated with the individual and previously stored information associated with the individual.

12. The method of claim 11, wherein the pre-designated locations are safety zones and check points.

13. The method of claim 12, wherein the act of determining that the individual has been accounted for is performed if the information associated with the individual was received at a safety zone, and the method further comprising generating a report that the individual has been accounted for.

14. The method of claim 13, further comprising:
determining whether any individuals have been unaccounted for; and
for each unaccounted individual, determining an approximate location of the unaccounted individual based at least in part on a location of a first check point where information associated with the unaccounted individual was last received

15. The method of claim 14, further comprising:
identifying that the unaccounted individual is moving based at least in part on a second check point receiving the information associated with the unaccounted individual; and
determining a pace of movement of the unaccounted individual based at least in part on when the information associated with the unaccounted individual was received at the first check point and the second check point, respectively, and a distance between the first check point and the second check point.

16. The method of claim 15, further comprising determining whether the unaccounted individual will arrive at a safety zone within a time period.

17. The method of claim 11, wherein the received information associated with the individual on the premises is identification information.

18. The method of claim 17, wherein the identification information originates from at least one of an identification card, an identification badge, a fingerprint, and a retina.

19. The method of claim 11, wherein the previously stored information associated with the individual is stored in a database and includes information corresponding to identity.

20. A computing device for emergency evacuation procedure and monitoring, the computing device comprising:
at least one processor executing stored program instructions to:
receive, via a plurality of scanning devices, information associated with an individual on a premises;
tally the received information associated with the individual; and
determine that the individual has been accounted for based at least in part on a match between the received information associated with the individual and previously stored information associated with the individual.
